(19) United States
(12) Patent Application Publication
(10) Pub. No.: US 2025/0166501 A1
(43) Pub. Date: May 22, 2025

(54) PRACTICAL METHOD TO COLLECT AND MEASURE TRAFFIC FLOW DATA THROUGH IP CAMERAS FOR ORIGIN-DESTINATION SURVEY STUDIES AND FOR OTHER USES

(71) Applicant: Francois Vaudrin, Quebec (CA)

(72) Inventor: Francois Vaudrin, Quebec (CA)

(21) Appl. No.: 18/516,888

(22) Filed: Nov. 21, 2023

(51) Int. Cl. G08G 1/01; G08G 1/04; G08G 1/081; G08G 1/095

(52) U.S. Cl. CPC G08G 1/0145; G08G 1/04; G08G 1/081; G08G 1/095

(57) ABSTRACT

Some widely acknowledged methods for gathering data on travel patterns are Origin-Destination (O-D) surveys and the Federal Highway Administration's National Household Travel Survey (NHTS) program, a well-established tool in transportation data. Typically conducted every five to eight years, these methods involve extensive and expensive data collection from thousands of households. The present invention aims to evaluate movements within urban areas with Internet Protocol cameras, distinguishing itself from traditional survey-based methods. Notably, our innovation allows for distinguishing various transportation modes, including goods and freight, providing expanded capabilities beyond traditional household-focused surveys.

### BACKGROUND OF THE INVENTION

Unlike traditional travel sampling methods, this innovation aims to assess the average movements of vehicle groups between locations instead of tracking each vehicle's entire journey from departure to destination. Additionally, this invention could serve other purposes, including management of traffic systems.

### TECHNICAL FIELD OF THE INVENTION

The invention belongs to the field of Intelligent Transportation Systems, research in transportation and mobility, and associated methodologies. More specifically, it addresses methodologies related to Origin-Destination surveys.

### DESCRIPTION OF THE PRIOR ART

To conduct traffic studies, it might be essential to have reliable, accurate, and up-to-date data on traffic flows. This comprehensive and easily accessible information is a crucial ingredient, enabling traffic engineers, experts, consultants, as well as cities and government agencies staff to effectively evaluate traffic issues.

In order to gather data, one of the most recognized method recommended by the FHWA is the National Household Travel Survey (NHTS) program, conducted every 5 to 8 years since 1969. This is typically an Origin-Destination survey that aimed to understand, for example, the commuting habits of residents and to analyze travel patterns. These trips could involve, for example, the daily journey from their home (Origin) to their workplace (Destination). (Source: FHWA NHTS REPORT: Travel Survey State of the Practice, March 2023).

Data collected can serve various purposes, including transport planning, assessing the impact of specific policies on mobility, analyzing the effects of the Covid-19 pandemic on travel behaviors, addressing traffic congestion issues, and planning infrastructure improvements. These insights can assist in assessing infrastructure use or planning enhancements to transportation systems.

However, Origin-Destination surveys present significant challenges due to their extensive data collection methods, involving interviews, online and paper questionnaires, and field investigations. For example, the 2022 NHTS, which began on Jan. 18, 2022, spanned on a one-year period and involved surveys from 7,500 households. Moreover, the Tennessee Department of Transportation (DOT) surveyed 5,000 households, the Virginia DOT surveyed 11,000 households, and the Oahu Metropolitan Planning Organization (MPO) surveyed 2,500 households (Source: FHWA NHTS REPORT: Travel Survey State of the Practice, March 2023)

Furthermore, these surveys may exhibit several limitations, including low response rates, under-representation of certain demographic groups such as minorities, inadequate sampling techniques, potential biases, and high costs. Moreover, misunderstandings of questions by respondents and potential misinterpretations of results by surveyors can introduce flaws into the data collected. Given that these surveys are conducted only every 5 to 8 years, this can result in potentially outdated data as travel habits may change.

Trying to obtain equivalent data through alternative methods would also pose challenges. For example, data collected from mobile devices and GPS navigation systems appear to be disseminated among several providers, and there might be legal, security, and privacy issues to consider. Furthermore, this alternative method would be different from the present invention.

Automatic license plate recognition systems may pose challenges, including legal and privacy issues. Tracking every vehicle's journey from departure to arrival points on a daily basis might be unfeasible, which also would be different from this invention.

Or, tracking every vehicle from departure to arrival using image recognition and artificial vision appears to be practically impossible, especially when considering potential legal and privacy issues. This alternative method would also be different from the present invention.

This invention might also enhance the effectiveness of current Traffic Light Systems. With nearly 300,000 Traffic Light Systems in United States deployed in accordance with the standards of the National Electrical Manufacturers Association (NEMA), the prospect of modifying them is deemed cost-prohibitive, and replacement is even more impractical. The invention might enhance these systems without the need for a complete overhaul, while respecting the practices of cities and public organizations.

It appears that the two widely deployed Traffic Light Systems (TLS) are the Static-TLS and the Adaptive-TLS: the main limitation of Static-TLS appears to be that they do not respond efficiently to demand variations. Other issue is that most of them do not seem to be updated frequently enough as data collection is too lengthy, costly, and imprecise (source: National Cooperative Highway Research Program: NCHRP, Synthesis 409, Traffic Signal Retiming Practices in the United States, p. 18-19); regarding Adaptive TLS, they appear to be too expensive to buy, install, and maintain. Also, they seem to be complicated to operate, and many experts doubt their effectiveness.

One widely recognized method for optimizing traffic signal sequences is the Webster's method, but it requires accurate and up-to-date traffic flow data. This invention may facilitate the collection of traffic flow data entering a city and that might help to adapt Traffic Light System. For example, the invention may enable the collection of traffic flow data entering a specific area within the city and the Center of Analysis and Treatment (30) can process data using the Webster method. Subsequently, the information may be transmitted to the Traffic Management Center (34), which can decide to modify the sequences of the Traffic Light Systems accordingly. These steps are detailed in the section: Description of the Invention.

The data collected through the present method can also be employed to calculate, for example, the optimal traffic speed based on the Fundamental Circulation Diagram theory, an essential foundation in traffic engineering. The data can be processed in line with the Fundamental Circulation Diagram, and this information can then be communicated to road users via Variable Message Signs, for example.

### BRIEF DESCRIPTION OF DRAWINGS

The FIG. 1 appears to be a complete view showing all the elements of the present method.

FIG. 2 appears to be an Origin-Destination matrix between different parts of an urban or metropolitan area.

### PARTS OF DRAWINGS

1 to 18 Vehicles
20 Method to collect and measure average traffic flow data through IP cameras for travel survey studies and other uses
26, 26′ Wireless data transmission system
28, 28′ The cloud
30 Center of Analysis and Treatment
32, 32′ Signal between the Wireless data transmission system and Center of Analysis and Treatment 30
34 Traffic Management Center
35 Screens, computers, software, equipment to monitor and manage traffic systems
44, 44′ Signal between the Wireless data transmission system and the cloud
48 Static Traffic Light System (Static-TLS)
48′ Adaptive Traffic Light System (Adaptive-TLS)
50, 50′ Signal between the Center of Analysis and Treatment 30 and the cloud 28, 28′
51 Real-time intervention transmission
52, 52′ Signal between the cloud and the city, agencies, public bodies 34
58 Signal between the Traffic Management Center 34 and the Traffic Light System 48
59 Signal between the Traffic Management Center 34 and Variable Message Sign 60
60 Variable Message Sign
100 to 106 IP cameras
100′ to 106′ Road sections
100″ to 106″ Transmission channels
200, 200′, 200″ Geographical sectors of a city or of a metropolitan area
300, 300′, 300″ Geographical sectors of a city or of a metropolitan area
500 Network of roads or highways in a metropolitan area
600 Origin-Destination Matrix

### DETAILED DESCRIPTION OF THE DRAWINGS

Building upon the insights from the previous sections, this section provides a detailed description of the present invention. It outlines the operational principles, practical applications, and how the invention would address the challenges mentioned earlier.

In the following description and in the accompanying drawings, the numeral numbers may refer to identical parts in the various figures. FIG. 1 shows all the elements of the present method 20 which include:

The FIG. 1 represents a network 500 of roads or highways which can surround, for example, a city or a metropolitan area.

The geographical sectors 200, 200′, 200″, 300, 300′, 300″ represent different parts of a city or a metropolitan area. An Origin-Destination survey seeks to measure the number of vehicles leaving one area 200, 200′, 200″ to go to another area 300, 300′, 300″, during the morning peak periods, for example.

The goal could be to estimate the routes from IP cameras 100, 101, 102, 103, 104, 105, 106.

These IP cameras take pictures of road sections 100′, 101′, 102′, 103′, 104′, 105′, 106′.

The present method may infer the paths to compare the circulation flow distribution on the network. For example, traffic flows of sections 100′, 101′, 102 merge at section 103′ and then separate at sections 104′, 105′, 106′. It could therefore possibly deduce the traffic flow distribution based on the percentage of vehicles that might come from one place to another place. For example, vehicles can come from 200, 200′, 200″, merge into section 103′, and separate further into 300, 300′, 300″.

It can be possible to measure these flows and compare each percentage relative to adjacent sections (e.g., to compare flow distribution from 200, 200′, 200″ and to compare flow distribution going to 300, 300′, 300″).

The traffic flow in each section can be measured with IP cameras 100, 102, 103, 104, 105, 106.

Vehicles 1 to 18, as well as other vehicles not numbered in the FIG. 1, which circulate on the network 500, appear to be cars, trucks, buses, motorcycles, bicycles, or any object, person, or animal which circulates there by any means of transport whatsoever.

In FIG. 1, seven IP cameras 100, 101, 102, 103, 104, 105, 106 appear to be installed along road sections; IP cameras take video images of road sections 100′, 101′, 102′, 103′, 104′, 105′, 106′, preferably in a synchronized way, but not necessarily.

In section 100′, IP camera 100 captures movements of vehicles 5, 6.

In section 101′, IP camera 101 captures movements of vehicles 7.

In section 102′, IP camera 102 captures movements of vehicles 8, 9.

In section 103′, IP camera 103 captures movements of vehicles 10, 11, 12, 13.

In section 104′, IP camera 104 captures movements of vehicles 14.

In section 105′, IP camera 105 captures movements of vehicles 15, 16.

In section 106′, IP camera 106 captures movements of vehicles 17, 18.

A Wireless data transmission system 26, 26′ could be connected to each IP camera and can receive data via transmission channels 100″, 101″, 102″, 103″, 104″, 105″, 106″.

The Wireless data transmission system 26, 26′ can transfer data 32, 32′ to a Center of Analysis and Treatment 30.

The Center of Analysis and Treatment 30 can process data to potentially estimate traffic flow on each road section 100′, 101′, 102′, 103′, 104′, 105′, 106′.

The Center of Analysis and Treatment 30 can validate the results and can use the method of its choice, such as monitoring and tracking a sample of vehicles by artificial vision algorithm.

Data could be sent 50, 50′ to the cloud 28, 28′ where they can be easily accessible in an appropriate format. This could be an automated way to get real-time traffic data for cities, agencies, and public bodies.

The Center of Analysis and Treatment 30 transmits data 51 to the Traffic Management Center 34 by fast and secure communication means.

Traffic Management Center 34 can be represented by a road viewing station, using screens and computers 35, where decisions can be made in real-time to manage traffic by operators, technicians, and engineers.

Traffic Management Center 34 intervenes dynamically in real-time and remotely to improve circulation movements.

Center of Analysis and Treatment 30 estimates the variation of traffic flow on section 104′ and transmits information to the Traffic Management Center 34, which intervenes remotely to change the duration of the Traffic Light System 48.

The Center of Analysis and Treatment 30 is shown in a separate building in FIG. 1 for illustrative purposes, but it can be located in the same building as Traffic Management Center 34.

Unlike conventional solutions that often necessitate significant modifications to the systems and infrastructures of cities and agencies, this invention might allows them to maintain full control of their operations, as illustrated in FIG. 1.

Link 58 between the Traffic Management Center 34 and the Traffic Lights System 48 can be a fast, secure and efficient means of transmission like a dedicated internet link, a fiber optic network, or any fast, secure and efficient communication means.

Traffic flow can be calculated or estimated in real-time on section 106′ and this information can be transmitted to the Center of Analysis and Treatment 30, and the latter can then transmit and display messages on a Variable Message Sign 60.

Center of Analysis and Treatment 30 transmits information to the Traffic Management Center 34, which can then inform drivers to adjust their speed or change lanes to reduce the risk of congestion.

Links 59 between the Traffic Management Center 34 and a Variable Message Sign 60 can be a secure means of transmission like a dedicated internet link, a fiber optic network, or any fast, secure and efficient communication means.

Pictures, videos, and data can be transmitted 44, 44′ to the cloud 28, 28′ where they can be accessible to cities, agencies, public bodies, and consultants according to their needs.

Cities, agencies, and public bodies can operate and optimize Traffic Light Systems 48 more frequently with the data obtained 52 and previously processed by the Center of Analysis and Treatment 30. They can also use data for other purposes such as travel planning, public transport studies, urban studies, geometric layouts, and so on.

Cities, agencies, and public bodies can transform a Static Traffic Light System 48 into a permanent Adaptive Traffic Light System 48′ by automating the transfer process between the Center of Analysis and Treatment 30, the Traffic Management Center 34 and the Traffic Light System 48, which then can becomes an Adaptive Traffic Light System 48′.

Link 51 can be a secure means of transmission like a dedicated internet link, a direct communication network, a fiber optic network, or any secure and fast communication means.

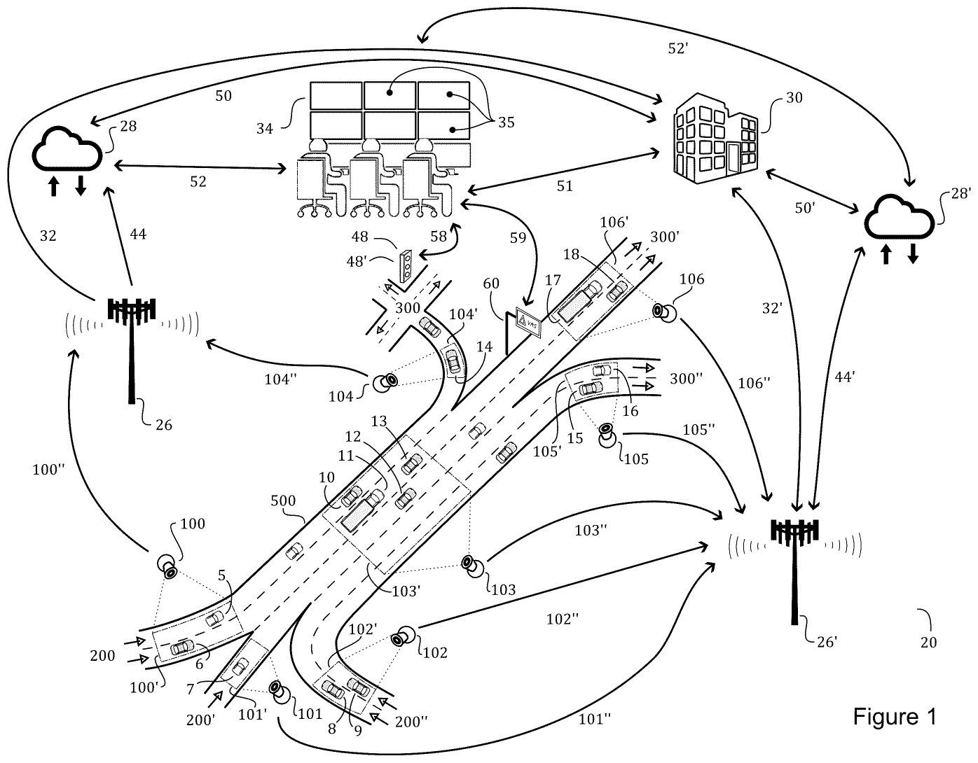

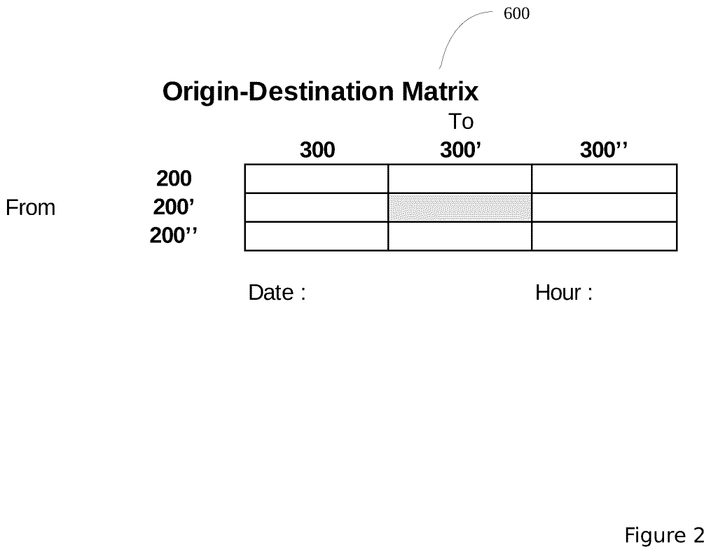

FIG. 2 shows an example of an Origin-Destination Matrix 600. This is an example of results that can be calculated and compared to traditional Origin-Destination surveys or Household Travel Survey for a metropolitan area.

The first column of the table appears to be the Origin sectors 200, 200′, 200″; the first row of the table appears to be the Destination sectors 300, 300′, 300″.

The intersection of columns and rows could show the flow measured on any day and at any time. For example, the center cell shows the flow calculated from the starting point Origin 200′ to the ending point Destination 300′.

The result would therefore appear in the table 600 as in a conventional Origin-Destination survey, which seems to be carried out every five to eight years using questionnaires, interviews, and sampling.

For example, if 20% of the traffic comes from 200′ and 50% of the 103′ section goes towards 300′, then 10% of 200′ theoretically goes towards 300′. This could be an example of an approach for measuring traffic distribution, but any other effective method can be used. This approach can be replicated on a larger network.

### DESCRIPTION OF THE INVENTION

The present invention appears to be a method 20 for measuring and processing real-time traffic data and accessing it via cloud computing.

The method can measure traffic flows at different locations on a road or highway network and can permit the estimation of traffic movements between different parts of a geographical region.

Since vehicles entering a section of road must somehow exit it, our method estimates traffic flow on different paths by comparing traffic flows on each road section 100′, 101′, 102′, 103′, 104′, 105′, 106′. By comparing the distribution of traffic flows, it may be possible to infer movements from an Origin 200, 200′, 200″ to a Destination 300, 300′, 300″.

IP cameras could be installed in suitable places to take pictures of road sections 101′ to 106′ where moving objects appear, like vehicles, pedestrians, cyclists, animals, or any other object. The pictures can be taken simultaneously, preferably, but not necessarily, to improve the accuracy of the results. Therefore, it may make it possible to infer traffic movements between different parts over a whole network surrounding an urban area.

The accuracy of the estimated traffic flow from an Origin to a Destination might depend on the number of IP cameras installed along the network. For example, if IP cameras are installed at all entry and exit points of the network as in FIG. 1, the accuracy of the data will be better.

It also makes it possible to use data for other purposes, such as to adjust Traffic Light Systems 48 according to the variation of traffic flow in road section 104′. Rather than scheduling the traffic lights statically for an entire period like the morning rush hour, it may be possible to dynamically change the traffic light schedule based on information transmitted by the Center of Analysis and Treatment 30 to the Traffic Management Center 34, which then applies remote changes to Traffic Light System 48.

It should be noted that most Traffic Light Systems appear to be static systems, meaning that the duration of cycles and phases cannot vary during each period (AM or PM peak hour). Our method may allow for dynamic intervention in these systems through the Traffic Management Center 34. It appears that most major cities are already equipped with a Traffic Management Center 34. Therefore, there seems to be no need to significantly modify the current Traffic Light Systems 48.

When the Traffic Management Center 34 transmits a signal 58 to the Static Traffic Light Systems 48 to modify the traffic light sequences, the latter automatically becomes a Dynamic Traffic Light System 48′ during the required period.

However, it might be possible to transform these Static Traffic Light Systems 48 into permanent Adaptive Traffic Light Systems 48′ by automating the interventions of the Traffic Management Center 34 according to the information transmitted by the Center of Analysis and Treatment 30.

Using this invention, it then appears that a city, agency, or public body can transform current Static Traffic Light Systems 48 into Dynamic Traffic Light Systems 48′ without significant changes in infrastructure, IT systems, internal processes, and at low cost.

Moreover, the present invention makes it possible to gather data in one place and to quickly access it at any time via the cloud.

The invention utilizes IP cameras 100 to 106 connected to transmission accessory channels 26, 26′, like 5G or any effective and secure communication link.

This invention might permit the comparison of traffic density and average speed on various road sections on the network, to predict congestion situations, and to intervene in real or near-real time.

The present invention might not be limited to a particular artificial vision algorithm, but it can be applied with any efficient algorithm. In order to identify vehicles, pedestrians, objects, or other moving objects in different lighting and visibility conditions, such as during the night and in various climatic conditions, lidar sensors and infrared IP cameras can be used in a similar fashion.

These data will be processed in the right format and accessible in the cloud to reduce data collection costs, field trips to collect data, and for updating Traffic Light Systems more frequently at a lower cost.

It also might allow the transfer of data to a micro-simulator or any kind of simulator in order to study traffic phenomena and to help develop more effective solutions in real-time, which can be adapted to driving habits and local culture.

Data obtained after the treatment of the pictures can be sent 50, 50′ to the cloud 28, 28′ and appear to be available 52, 52′ to the Traffic Management Center 34 of cities, agencies, or public bodies for different purposes; management of traffic lights, management of traffic control systems, studies related to transport and urban planning.

The Traffic Management Center 34 can receive real-time interventions or suggestions from the Center of Analysis and Treatment 30 to improve traffic mobility.

According to a preferred embodiment of the invention a method for collecting and measuring real-time traffic data and permitting, among other things is provided, to estimate traffic flow movements from an Origin to a Destination of a road network, comprising at least one of the following steps:
Choose a series of Internet Protocol (IP) cameras (100, 101, 102, 103, 104, 105, 106), and/or
Install said IP cameras at different road sections (100′, 101′, 102′, 103′, 104′, 105′, 106′) in order to capture pictures of moving vehicles (5 to 18), pedestrians, cyclists, animals, and moving objects at said road sections, and/or

Preferably, but not necessarily, synchronize all said IP cameras so that they take series of said pictures every fraction of a second during the same approximate laps of time from said road sections (100′, 101′, 102′, 103′, 104′, 105′, 106′), and/or

Connect said IP cameras to a Wireless data transmission system (26, 26′) in order to transfer said pictures by secure, efficient, and rapid means to a Center of Analysis and Treatment (30), and/or

Access and process said pictures at said Center of Analysis and Treatment (30) in order to obtain real-time traffic data and to estimate average traffic flow from said road sections (100′, 101′, 102′, 103′, 104′, 105′, 106′), and/or

Process said real-time traffic data collected by said IP cameras (100, 101, 102, 103, 104, 105, 106) at said Center of Analysis and Treatment (30) in order to propose intervention scenarios to a Traffic Management Center (34) to enable it to intervene remotely, dynamically, and in real-time on Traffic Light System (48), in order to improve traffic management and mobility, and/or

To measure the traffic flow, the IP camera 104 can be used, which captures video images of section 104′. These images can then be transmitted to the Center of Analysis and Treatment 30, by fast, secure and efficient means of communication 26′ and 32, such as a dedicated fast Internet line or a dedicated optical fiber, and/or

The images can then be analyzed and processed in the Center of Analysis and Treatment 30 using an efficient computer vision algorithm to measure the traffic flow on section 104′, for example by counting the number of vehicles and their average speed, and/or

Knowing the traffic flow in real time, the Center of Analysis and Treatment 30 can use Webster's method to revise the optimal phase and cycle duration of the Static Traffic Light System 48, and/or

This new sequence can then be considered as an intervention scenario that the Center of Analysis and Treatment 30 can transmit to the Traffic Management Center 34 through a fast, secure and efficient transmission channel 51, and/or

The Traffic Management Center 34 operated by operators, technicians or engineers can modify the real-time sequences of the Static Traffic Light System 48 in a fast, secure and efficient way 58, and/or

It is also possible to make the previous process automatic to permanently transform a Static Traffic Light System 48 into an Adaptive Traffic Light System 48′ without significantly modifying the existing infrastructures and the internal IT systems of the city, the agency or of the public body, and/or

The variable messages displayed on the panel 60 may follow a similar process through the transmission channel 59 and the Center of Analysis and Treatment 30 might use the Fundamental Diagram to estimate the optimum speed based on the flow rate measured on Section 103 and the Traffic Management Center 34 may display the recommended speed, and/or

Process said real-time traffic data collected by said IP cameras (100, 101, 102, 103, 104, 105, 106) at said Center of Analysis and Treatment (30) in order to propose intervention scenarios to a Traffic Management Center (34) to enable it to intervene remotely, dynamically, and in real-time on Variable Message Sign (60), and/or

Send said real-time traffic data to the cloud (28, 28′) and make it securely accessible and in an appropriate format to agencies, cities, public bodies, and others for different uses according to their needs.

### BRIEF SUMMARY OF THE INVENTION

Comprehensive, accurate, and easily accessible traffic data is essential for traffic engineers, experts, consultants, as well as city and government agency staff to effectively assess traffic issues. However, these data often lack accuracy or are not up-to-date.

A recognized method commonly employed by public administrations is through Origin-Destination surveys that aim to better understand the travel habits of individuals or households. However, they present limitations due to their extensive data collection from interviews, online and paper questionnaires, and field investigations.

The present invention is designed to go beyond traditional survey methods by offering accessible, more frequent, and up-to-date data collection through strategically installed IP cameras. This approach aims to estimate traffic movements between various sections of a city or metropolitan area.

For instance, in many medium-sized cities, a network of collector highways encompasses numerous entrances and exits. When vehicles enter this network via an entrance, they inevitably exit elsewhere. Rather than monitoring each vehicle's specific journey from its starting point to its destination, the present invention suggests capturing and analyzing traffic flows distribution across this network.

To facilitate the capture of traffic flow, the proposed method involves the installation of a series of strategically positioned IP cameras. This enhancement aims to improve the accuracy of existing traditional methods, such as the Federal Highway Administration's National Household Travel Survey (NHTS).

This data could, for example, allow engineers and transportation experts to model traffic movements. Additionally, this invention could deliver more accurate and frequent traffic flow data, facilitating the generation of comprehensive traffic flow histories that span various days, months and seasons. Importantly, it can allows for the distinction of various transportation modes, including the movement of goods and freight within metropolitan areas, an expanded capability beyond traditional surveys that primarily focus on households.

1. A method for collecting and measuring real-time traffic data and permitting, among other things, to estimate traffic flow movements from an Origin to a Destination of a road network, comprising the following steps:
(a) Choose a series of Internet Protocol (IP) cameras (100, 101, 102, 103, 104, 105, 106),
(b) Install said IP cameras at different road sections (100′, 101′, 102′, 103′, 104′, 105′, 106′) in order to capture pictures of moving vehicles (5 to 18), pedestrians, cyclists, animals, and moving objects at said road sections,
(c) Preferably, but not necessarily, synchronize all said IP cameras so that they take series of said pictures every fraction of a second during the same approximate laps of time from said road sections (100′, 101′, 102′, 103′, 104′, 105′, 106′),
(d) Connect said IP cameras to a Wireless data transmission system (26, 26′) in order to transfer said pictures by secure, efficient, and rapid means to a Center of Analysis and Treatment (30),
(e) Access and process said pictures at said Center of Analysis and Treatment (30) in order to obtain real-time traffic data and to estimate average traffic flow from said road sections (100′, 101′, 102′, 103′, 104′, 105′, 106′),
(f) Process said real-time traffic data collected by said IP cameras (100, 101, 102, 103, 104, 105, 106) at said Center of Analysis and Treatment (30) in order to propose intervention scenarios to a Traffic Management Center (34) to enable it to intervene remotely, dynamically, and in real-time on Traffic Light System (48), in order to improve traffic management and mobility,
(g) Process said real-time traffic data collected by said IP cameras (100, 101, 102, 103, 104, 105, 106) at said Center of Analysis and Treatment (30) in order to propose intervention scenarios to a Traffic Management Center (34) to enable it to intervene remotely, dynamically, and in real-time on Variable Message Sign (60),
(h) Send said real-time traffic data to the cloud (28, 28′) and make it securely accessible and in an appropriate format to agencies, cities, public bodies, and others for different uses according to their needs.

2. The method of claim 1 wherein said Center of Analysis and Treatment (30) processes said pictures of said road sections in order to estimate the average traffic flow from an Origin sector (200, 200′, 200″) to a Destination sector, similarly to an Origin-Destination Matrix (600).

3. The method of claim 2 wherein said Center of Analysis and Treatment (30) uses any accurate approach to obtain accurate said average traffic flow from an Origin sector (200, 200′, 200″) to a Destination sector (300, 300′, 300″).

4. The method of claim 2 wherein said Center of Analysis and Treatment (30) uses any appropriate artificial intelligence approaches to process said pictures in order to obtain accurate said real-time traffic data.

5. The method of claim 1 wherein said pictures can be processed directly by each said IP camera (100, 101, 102, 103, 104, 105, 106) in order to transfer already partially processed data to the Center of Analysis and Treatment (30).

6. The method of claim 1 wherein said Traffic Management Center (34) is connected to said Traffic Light System (48) by a fast and secure communication system (58) for commanding remotely said Traffic Light System in real-time.

7. The method of claim 1 is used to process traffic information data in said Center of Analysis and Treatment (30), to transmit said processed traffic information data to said Traffic Management Center (34) for commanding remotely Variable Message Sign (60), and to transmit messages to drivers by appropriate means (59).

8. The method of claim 1 wherein said cities is connected to said cloud (28, 28′) for easy accessing said traffic data.

9. The method of claim 1 wherein different lighting and visibility conditions on the roadside said IP cameras are used with lidar sensors.

10. The method of claim 1 wherein different lighting and visibility conditions on the roadside said IP cameras are used with infrared IP cameras.

11. The method of claim 1 wherein said Wireless data transmission system (26, 26′) is an accurate and secure transmission system.

12. The method of claim 1 wherein said real time data can be transferred into a micro-simulator in order to study traffic phenomena and to intervene, if necessary, in real time via the Traffic Management Center (34).

13. The method of claim 1 wherein said cities, agencies, public bodies and consultants can manage transport, mobility and urban planning by the mean of said real-time traffic data.

14. The method of claim 1 wherein said real-time traffic data can be anonymized to respect legal and privacy issues.

15. The method of claim 1 wherein said real-time traffic data can be used to transform Static Traffic-Light-Systems (48) to Adaptive Traffic-Light-Systems (48′).

16. The method of claim 15 wherein said Static Traffic-Light-Systems can be transform to said Adaptive Traffic-Light-Systems without implemented costly and fundamental changes in current infrastructure, into computer systems and into IT systems currently in force in cities, agencies and public bodies.
